(19) United States
(12) Patent Application Publication
(10) Pub. No.: US 2013/0194274 A1
(43) Pub. Date: Aug. 1, 2013

(54) COMPUTER-READABLE RECORDING MEDIUM STORING A GRAPH GENERATION PROGRAM, GRAPH GENERATING METHOD, AND PRODUCTION MANAGEMENT DEVICE

(71) Applicant: FUJITSU LIMITED, Kawasaki-shi (JP)

(72) Inventor: Tatsuya ISHIHARA, Yokohama (JP)

(73) Assignee: FUJITSU LIMITED, Kawasaki-shi (JP)

(21) Appl. No.: 13/727,641

(22) Filed: Dec. 27, 2012

(30) Foreign Application Priority Data
Jan. 27, 2012 (JP) 2012-015690

(51) Int. Cl. G06T 11/20

(52) U.S. Cl. CPC G06T 11/20
USPC 345/440

(57) ABSTRACT

A computer-readable recording medium storing a program including a procedure, the procedure includes: receiving an instruction for generating a graph regarding production of a product in a chronological manner for each of first unit period and second unit period that is longer than the first unit period; referring to aggregate data on production volumes for individual unit periods, and calculating, based on a production volume for a different unit period having a length that is different from a length of a designated unit period of the first unit period and the second unit period, a different production volume to be obtained by converting the different unit period into the designated unit period; and generating the graph in such a manner that at least the different production volume is indicated for the different unit period that is different from the designated unit period.

### CROSS-REFERENCE TO RELATED APPLICATION

This application is based upon and claims the benefit of priority of the prior Japanese Patent Application No. 2012-015690, filed on Jan. 27, 2012, the entire contents of which are incorporated herein by reference.

### FIELD

A technique disclosed in the embodiments is related to generation of a graph.

### BACKGROUND

In the case of producing products, production management for controlling bases to produce products in accordance with a production plan in which the planned daily production volume is designed for a specific period such as a quarter-year, a half-year, or a full-year is performed. In such a production plan, the planned production volume for which the demand and supply of products are balanced is designed on the basis of a sales plan in which the sales volume is designed in accordance with the demand for products. Thus, a production plan has characteristics in which the reliability is higher in a nearer future from the point in time when the plan is designed and the reliability is lower in a further future from the point in time when the plan is designed.

From the above-mentioned point of view, as a technique for visualizing the trend of the planned production volume, a graph generating method for converting, using a plurality of time buckets having different units of period, planned production volumes for the individual time buckets into a graph has been suggested. This graph generating method is disclosed in Japanese Laid-open Patent Publication No. 2002-163666. In this graph generating method, a time axis representing the passage of time is divided into a section including weekly time buckets and a section including monthly time buckets in descending order of proximity to the origin of the time axis, and a bar graph representing planned production volumes for the individual sections is generated. Accordingly, a production planner is able to understand an accurate trend for a nearer future and understand a big-picture trend for a further future. Thus, in the case of distributing production of products to bases, distribution of the production is smoothed.

### SUMMARY

According to an aspect of the invention a computer-readable recording medium storing a program for causing a computer to execute a procedure for graph generation, the procedure includes: receiving an instruction for generating a graph regarding production of a product in a chronological manner for each of first unit period and second unit period that is longer than the first unit period; referring to aggregate data on production volumes for individual unit periods including the first unit period and the second unit period, and calculating, based on a production volume for a different unit period having a length that is different from a length of a designated unit period of the first unit period and the second unit period, a different production volume to be obtained by converting the different unit period into the designated unit period; and generating the graph in such a manner that at least the different production volume is indicated for the different unit period having the length that is different from the length of the designated unit period.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the configuration of a production management system according to a first embodiment;

FIG. 2 is a block diagram illustrating the functional configuration of a production management server according to the first embodiment;

FIG. 3 is a diagram illustrating an example of production plan data;

FIG. 4 is a diagram illustrating an example of aggregate data;

FIG. 5 is a diagram illustrating an example of a graph;

FIG. 6 is a diagram illustrating an example of a graph;

FIG. 7 is a diagram illustrating an example of a graph;

FIG. 8 is a flowchart illustrating the procedure of an aggregation process according to the first embodiment;

FIG. 9 is a flowchart illustrating the procedure of a graph generating process according to the first embodiment; and

FIG. 10 is a diagram for explaining an example of a computer that executes graph generating programs according to the first embodiment and second embodiment.

### DESCRIPTION OF EMBODIMENTS

In the graph generating method mentioned above, a bar graph in which planned production volumes for different time buckets exist is generated. Thus, when the comparison is simply made between the height of a bar for a section on a weekly basis and the height of a bar for a section on a monthly basis, the magnitude of the planned production volume is not determined. As described above, the size relationship between the planned production volume for the section on the weekly basis and the planned production volume for the section on the monthly basis is not clear from the comparison made only between the heights of bars of the graph generated by the graph generating method mentioned above. Thus, in one aspect, there is a lack of visibility of the graph.

The technique disclosed herein has been designed in view of the above-mentioned points and an object of the technique is to improve the visibility of a graph.

Hereinafter, embodiments of a graph generating program, a graph generating method, and a production management device disclosed in this application will be explained in detail with reference to the drawings. The embodiments do not limit the disclosed technique. The individual embodiments may be appropriately combined together as long as no contradiction arises in the processing details.

### First Embodiment

[System Configuration]

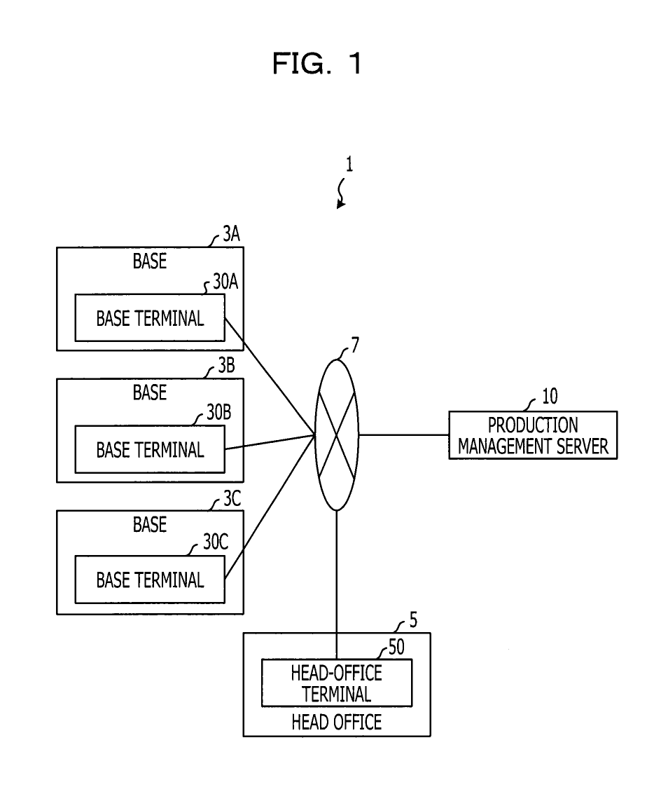

First, the configuration of a production management system according to this embodiment will be explained. FIG. 1 is a diagram illustrating the configuration of a production management system according to a first embodiment. A production management system 1 illustrated in FIG. 1 is a system for managing production of products by bases 3A to 3C in accordance with a production plan in which the planned daily production volume for a specific period is designed. As part of the production management, the production management system 1 provides for a production planner of a head office 5 a graph generating service for generating a graph representing the relationship between the planned production volume and the passage of time.

As illustrated in FIG. 1, a production management server 10, base terminals 30A to 30C, and a head-office terminal 50 are accommodated in the production management system 1. Although three base terminals and one head-office terminal are illustrated in the example of FIG. 1, the disclosed system is not limited to the illustrated configuration. That is, the production management system 1 is capable of accommodating a desired number of base terminals and head-office terminals. Hereinafter, the bases 3A to 3C may be referred to as “bases 3” in the case where the bases 3A to 3C are generically referred to without distinction among the bases 3A to 3C, and the base terminals 30A to 30C may be referred to as “base terminals 30” in the case where the base terminals 30A to 30C are generically referred to without distinction among the base terminals 30A to 30C.

The production management server 10, the base terminals 30, and the head-office terminal 50 are connected so as to communicate with one another over a network 7. A communication network of a desired type, such as the Internet, a LAN (Local Area Network), or a VPN (Virtual Private Network), irrespective of wired or wireless connection, may be adopted as the network 7.

The base terminals 30 are terminal devices that are arranged at the bases 3 such as production plants producing products and stores selling products. For example, as the base terminals 30, a fixed terminal, such as a personal computer (PC), and a mobile terminal, such as a cellular phone, a PHS (Personal Handyphone System), and a PDA (Personal Digital Assistant), may be adopted. The base terminals 30 are used by members of the bases 3, such as a person in charge of a production department, a person in charge of a sales department, and the like.

The base terminals 30 store and manage data regarding production plans, sales plans, and inventory plans for the bases 3, that is, PSI plan data. The PSI plans for the bases 3 mentioned here are local PSI plans exclusive to the bases 3A to 3C. Thus, hereinafter, the PSI plans for the bases 3 may be described as “L-PSI plans”. Meanwhile, PSI plans stored and managed by the production management server 10 are global PSI plans for supervising all the bases 3. Thus, hereinafter, the PSI plans stored and managed by the production management server 10 may be described as “G-PSI plans”.

The head-office terminal 50 is a terminal device that is arranged at the head office 5 supervising the bases 3A to 3C. As an example of the head-office terminal 50, a fixed terminal, such as a personal computer, or a mobile terminal, such as a PHS or a PDA, may be adopted. Here, the head-office terminal 50 is used by a member of the head office 5, such as a person in charge of a production department, a person in charge of a sales department, or the like. Furthermore, although the case where the head-office terminal 50 functions as a client is exemplified here, the head-office terminal 50 may function as the production management server 10.

The base terminals 30 and the head-office terminal 50 transmit and receive various data via the production management server 10 that performs master management of L-PSI plans and G-PSI plans. In an aspect, the base terminals 30 upload L-PSI plan data to the production management server 10. The L-PSI plan data contains the daily production volume, order volume, and inventory volume for individual products. In another aspect, the head-office terminal 50 sets planned production volumes for the bases 3 for the production plan data contained in the L-PSI plan data, and the planned production volumes are downloaded to the base terminals 30. As the planned production volumes for the bases 3, certain amounts of the planned total product production volume for all the bases 3 are distributed to the bases 3 by a person in charge of the production department of the head office 5, on the basis of the planned total product production volume for all the bases, the order condition and the inventory condition of products, the production capacity and the loaded condition of facilities of plants of the bases 3, and the like.

The production management server 10 is a server device that performs production management for products. The production management server 10 may be implemented as a Web server or cloud. In an aspect, when receiving from the head-office terminal 50 an instruction for generating a graph, the production management server 10 generates a graph representing the relationship between the planned production volume and the passage of time using the planned product production volume in production plan data of G-PSI plan data, and supplies the generated graph to the head-office terminal 50. In another aspect, when receiving from a base terminal 30 an instruction for generating a graph, the production management server 10 generates a graph representing the relationship between the planned production volume and the passage of time using the planned product production volume in production plan data of L-PSI plan data, and supplies the generated graph to the base terminal 30.

Here, the production management server 10 according to this embodiment receives an instruction for generating a graph. The production management server 10 according to this embodiment also acquires the designation of the size of a time bucket representing the unit of a period. The production management server 10 according to this embodiment also coverts, for individual time frames, the planned production volume associated with a time frame having a size different from the designated time-bucket size, of production plan data associated with the planned production volume of a product, into the planned production volume for a time frame having the same size as the designated time-bucket size. Time frames are arranged in a chronological order, and the size of a time bucket is changed at a specific boundary value. The production management server 10 according to this embodiment also generates a graph representing the relationship between the planned production volume of a product and the passage of time, using the converted production volume.

As described above, in the case where planned product production volumes for different time-bucket sizes exist in a graph to be generated, the production management server 10 according to this embodiment converts the planned production volume for a time-bucket size into the planned production volume for a different time-bucket size, and then generates a graph. For example, a person in charge of a production department is able to determine the magnitude of the planned production volume only by simply comparing the height of a bar on a weekly basis of the graph with the height of a bar on a monthly basis of the graph. Therefore, the person in charge of the production department is able to understand, without interruption, the trend of the planned production volume before and after the boundary at which the time-bucket size changes.

Accordingly, with the production management server 10 according to this embodiment, the visibility of a graph is improved. For example, for viewing of a graph by the person in charge of the production department of the head office 5, a graph may be generated in which the planned production volume on a weekly basis is converted into the planned production volume per month and time-course changes in the planned production volumes on the weekly basis and the monthly basis are represented. Thus, the person in charge of the production department of the head office 5 is able to understand, without interruption, a big-picture trend of the planned production volume before and after the boundary at which the indication of the graph changes from the weekly basis to the monthly basis. Therefore, in the case where the person in charge of the production department of the head office 5 distributes product production to bases, a graph that is useful for smoothing the production distribution may be provided. Furthermore, for viewing of a graph by a person in charge of a production department of a base 3, a graph may be generated in which the planned production volume on a weekly basis is converted into the planned production volume per day and time-course changes in the planned production volumes on the weekly basis and the daily basis are represented. Thus, the person in charge of the production department of the base 3 is able to understand, without interruption, an accurate trend of the planned production volume before and after the boundary at which the indication of the graph changes from the daily basis to the weekly basis. Therefore, a graph useful for operating the plant of the base 3 may be provided.

[Configuration Of Production Management Server 10]

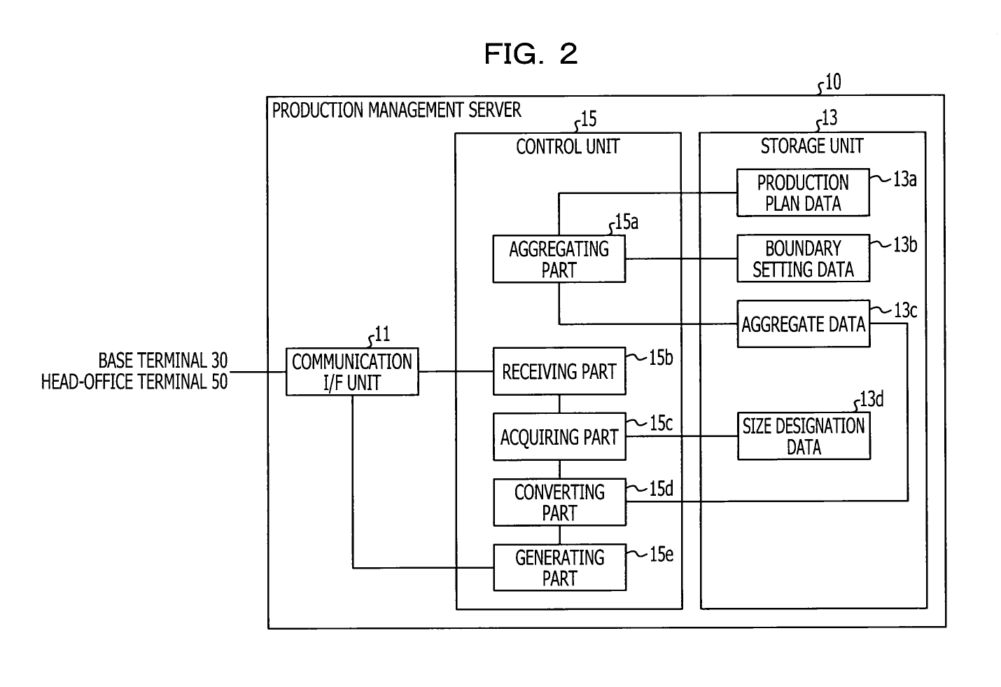

The functional configuration of the production management server 10 according to this embodiment will now be explained. FIG. 2 is a block diagram illustrating the functional configuration of the production management server 10 according to the first embodiment. As illustrated in FIG. 2, the production management server 10 includes a communication I/F (interface) unit 11, a storing unit 13, and a control unit 15. The production management server 10 may include various functional units provided in a known server device, such as, for example, an input device and an audio output device, as well as the functional units illustrated in FIG. 2.

The communication I/F unit 11 is an interface that performs communication control for external devices, such as the base terminals 30A to 30C and the head-office terminal 50. As an aspect of the communication I/F unit 11, a network interface card such as a LAN card may be adopted. For example, the communication I/F unit 11 receives from the head-office terminal 50 and the base terminals 30 graph generating instructions and transmits to the head-office terminal 50 and the base terminals 30 graphs generated by the production management server 10.

The storing unit 13 is a storage device that stores an OS (Operating System) and various programs such as a graph generating program for providing a graph generating service that are executed by the control unit 15. In an aspect, the storing unit 13 is a semiconductor memory element, such as a flash memory, a storage device, such as a hard disk or an optical disk, or the like. The storing unit 13 is not limited to the storage device of the above-mentioned types. The storing unit 13 may be a RAM (Random Access Memory) or a ROM (Read Only Memory).

The storing unit 13 stores production plan data 13a, boundary setting data 13b, aggregate data 13c, and size designation data 13d, which are examples of data to be used for execution of a program to be executed by the control unit 15. Although only the production plan data 13a of G-PSI plan data is illustrated in the example of FIG. 2, sales plan data, inventory plan data, and L-PSI plan data for the bases 3 are also stored.

The production plan data 13a is data regarding a production plan including planned daily production volumes of individual products. The planned production volume represents, for example, the planned volume of a product to be produced by all the bases 3A to 3C. For example, as the production plan data 13a, the planned daily production volume set by a person in charge of the production department of the head office 5 on the basis of a sales plan and an inventory plan is registered. For another example, from the viewpoint in which planned production volumes for time buckets with coarser granularities are plotted in a graph as the time passes on the time axis of the graph, in the case where the planned production volumes on a daily basis are aggregated into the planned production volume on a weekly basis or a monthly basis, the production plan data 13a is referred to by an aggregating part 15a, which will be described later.

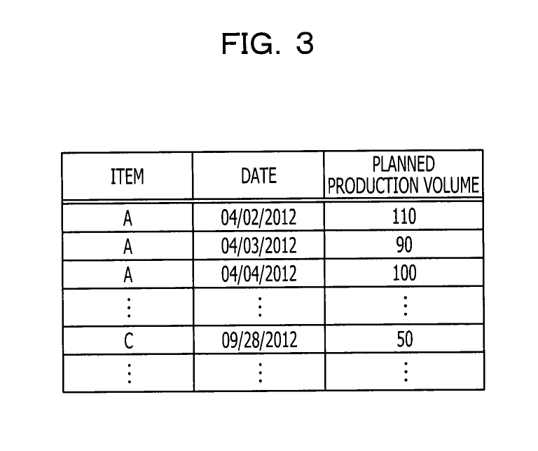

As an aspect of the production plan data 13a, data in which “item”, “date”, and “planned production volume” are associated with one another may be adopted. FIG. 3 is a diagram illustrating an example of the production plan data 13a. The diagram represents that regarding an item “A” of the products illustrated in FIG. 3, 110 units are planned to be produced on Apr. 2, 2012, 90 units are planned to be produced on Apr. 3, 2012, and 100 units are planned to be produced on Apr. 4, 2012. The diagram also represents that regarding an item “C” of the products illustrated in FIG. 3, 50 units are planned to be produced on Sep. 28, 2012. Although only part of a production plan for the item “A” and the item “C” of the products is illustrated in the example of FIG. 3, actually, a person in charge of the production department of the head office 5 sets a production plan for the first half of the year and the second half of the year. Furthermore, although the case where the number of units represents the product volume is exemplified in the example of FIG. 3, representation of the volume is not limited to the number of units, and for example, “dozen” may be used as a unit representing the volume.

Here, although production plan data in which the planned production volume is associated with an item is exemplified in the example of FIG. 3, product identification information associated with the planned production volume may not be an item. For example, the device disclosed herein may store planned production data in which, instead of an item, “type”, that is, a so-called series item, is associated with the planned production volume. The “type” mentioned here represents an item group, which is a series of items having a certain commonality. For example, type may be used as the unit of products managed as G-PSI plan data by the production management server 10, and the L-PSI plan data may be distributed in such a manner that each of the items belonging to the type is used as a unit in the case where the planned production volume is distributed to the individual bases 3.

The boundary setting data 13b is data defining settings for a boundary value at which the time-bucket size is changed. For example, the boundary setting data 13b is referred to by the aggregating part 15a, which will be described later, in the case where the planned production volumes on a daily basis are aggregated by converting the size of a daily time-bucket into a weekly basis or a monthly basis. Regarding the boundary setting data 13b, a desired boundary is set by an authorized person who has an authority to view a graph, such as a person in charge of the production department of the head office 5.

As an aspect of the boundary setting data 13b, data associated with “the number of days” representing the planned production volume on a daily basis starting from the starting date defined as the origin of the time axis of a graph, “the number of weeks” representing the planned production volume on a weekly basis starting from the date immediately after the indication finish date on the daily basis, and “the number of months” representing the planned production volume on a monthly basis starting from the date immediately after the indication finish date on the weekly basis may be adopted. Regarding the “number of weeks”, in order to start aggregation of the planned production volumes on the monthly basis from the first date of a month, designation for a period to the end of a month, instead of the number of weeks, may be accepted. Although the case where the number of days, the number of weeks, and the number of months from the starting date of the time axis of a graph are set as boundaries is exemplified in this example, the indication finish date on the daily basis, the indication finish date on the weekly basis, and the indication finish date on the monthly basis may be set as boundaries.

All “the number of days”, “the number of weeks”, and “the number of months” may not set for the boundary setting data 13b. For example, in the case where “the number of weeks” and “the number of months” are set for the boundary setting data 13b, the planned production volumes on the weekly basis and the monthly basis are converted into a graph but the planned production volume on a daily basis is not converted into a graph. Furthermore, in the case where “the number of days” and “the number of weeks” are set for the boundary setting data 13b, the planned production volumes on the daily basis and the weekly basis are converted into a graph but the planned production volume on the monthly basis is not converted into a graph. Furthermore, in the case where “the number of days” and “the number of months” are set for the boundary setting data 13b, the planned production volumes on the daily basis and the monthly basis are converted into a graph but the planned production volume on the weekly basis is not converted into a graph.

The aggregate data 13c is data representing the planned product production volume obtained by aggregating the planned product production volumes on the daily basis for individual sizes of time buckets. For example, as the aggregate data 13c, the aggregate value of a product obtained by changing the time-bucket size into a weekly basis or a monthly basis is registered by the aggregating part 15a, which will be described later. For another example, in order to convert the planned production volume for a time-bucket size that is different from a designated time-bucket size into the planned production volume per the designated time-bucket size, the aggregate data 13c is referred to by a converting part 15d, which will be described later.

As an aspect of the aggregate data 13c, data in which “time frames”, which are arranged in a chronological order and for which the time-bucket size is changed between before and after the boundary value, and “planned production volumes” are associated with each other may be adopted. Regarding the “time frames”, the frames may be each determined by defining the start date and the finish date for the time frame.

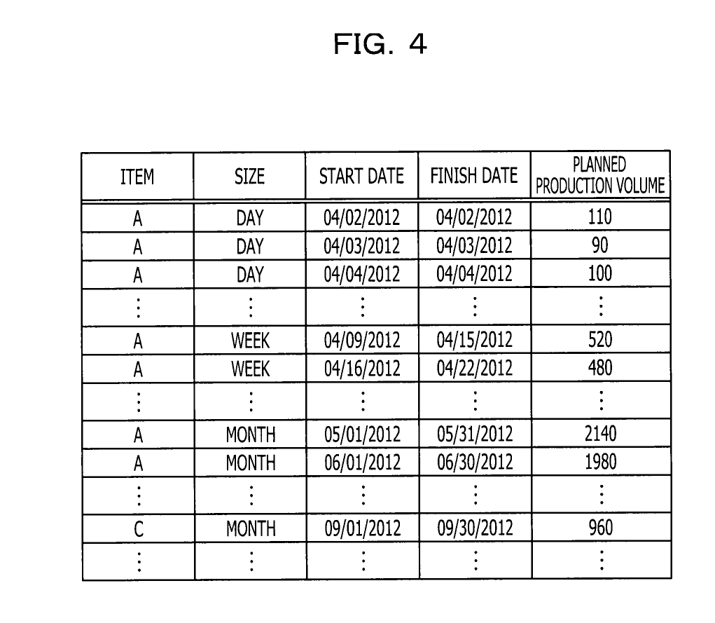

FIG. 4 is a diagram illustrating an example of the aggregate data 13c. In the example of FIG. 4, it is assumed that the size of time buckets for the period from Apr. 2, 2012 to Apr. 8, 2012 is on a daily basis, the size of time buckets for the period from the week starting from Apr. 9, 2012 to the end of April 2012 is on a weekly basis, and the size of time buckets for the period from May 2012 is on a monthly basis.

In the example of the item “A” in FIG. 4, the diagram represents that the planned production volume for Apr. 2, 2012 is 110 units, the planned production volume for Apr. 3, 2012 is 90 units, and the planned production volume for Apr. 4, 2012 is 100 units. Furthermore, in the example of the item “A” in FIG. 4, the planned production volume for the week starting from Apr. 9, 2012 is 520 units, and the planned production volume for the week starting from Apr. 16, 2012 is 480 units. Furthermore, in the example of the item “A” in FIG. 4, the planned production volume for May 2012 is 2140 units, and the planned production volume for June 2012 is 1980 units.

The size designation data 13d is data in which a designated time-bucket size is set. An aspect of the size designation data 13d includes data representing a time-bucket size on a daily basis, a weekly basis, a monthly basis, or the like. For the size designation data 13d, at least one time-bucket size may be designated. A plurality of time-bucket sizes may be designated. For example, in order to determine as to into which bucket size, daily basis, weekly basis, or monthly basis, conversion is to be performed, the size designation data 13d is referred to by the converting part 15d, which will be described later. For the size designation data 13d, a desired time-bucket size is designated by an authorized person who has an authority to view a graph, such as, for example, a person in charge of the production department of the head office 5.

The control unit 15 includes an internal memory for storing a program defining various processing procedures and control data and performs various processes in accordance with the program and the control data. As illustrated in FIG. 2, the control unit 15 includes the aggregating part 15a, a receiving part 15b, an acquiring part 15c, the converting part 15d, and a generating part 15e.

The aggregating part 15a is a processing part that aggregates the planned production volumes on a daily basis into the planned production volume on a weekly basis or the planned production volume on a monthly basis, using the production plan data 13a and the boundary setting data 13b.

As an aspect, the aggregating part 15a first initializes the aggregation start date to the starting date of the time axis of a graph, and reads the boundary setting data 13b stored in the storing unit 13. Then, the aggregating part 15a determines whether or not “the number of days” is set for the boundary setting data 13b. When “the number of days” is set for the boundary setting data 13b, the aggregating part 15a updates the aggregation start date, on which aggregation of the production plan data 13a starts, by adding the number of days for which the planned production volumes on the daily basis are to be indicated to the starting date of the time axis of the graph. When “the number of days” is not set for the boundary setting data 13b, since the planned production volumes on the daily basis are not indicated in a graph to be generated and indication starts from the planned production volumes on the weekly basis, the starting date of the time axis of the graph is directly set to the date on which indication of the planned production volumes on the weekly basis starts. Thus, in this case, the aggregation start date is not updated.

Then, the aggregating part 15a determines whether or not “the number of weeks” is set for the boundary setting data 13b. When “the number of weeks” is set for the boundary setting data 13b, the aggregating part 15a sets time frames on the weekly basis for the period from the starting date, which is the aggregation start date, to the finish date, which is the date after the number of weeks set for the boundary setting data 13b has passed. Then, the aggregating part 15a aggregates the planned production volumes on the daily basis within the set time frames of the planned production volumes of the production plan data 13a into the planned production volumes on the weekly basis. Then, the aggregating part 15a updates the aggregation start date by adding the number of weeks for which the planned production volumes on the weekly basis are to be indicated to the aggregation start date stored in the internal memory, which is not illustrated. When “the number of weeks” is not set for the boundary setting data 13b, since the planned production volumes on the weekly basis are not indicated in a graph to be generated, aggregation on the weekly basis and updating of the aggregation start date are not performed.

Then, the aggregating part 15a determines whether or not “the number of months” is set for the boundary setting data 13b. When “the number of months” is set for the boundary setting data 13b, the aggregating part 15a sets time frames on the monthly basis for the period from the starting date, which is the aggregation start date, to the finish date, which is the date after the number of months set for the boundary setting data 13b has passed. Then, the aggregating part 15a aggregates the planned production volumes on the daily basis within the set time frames of the planned production volumes of the production plan data 13a into the planned production volumes on the monthly basis. Then, the aggregating part 15a registers to the storing unit 13, as the aggregate data 13c, data in which the planned production volumes on the daily basis, the planned production volumes on the weekly basis, and the planned production volumes on the monthly basis for the number of days set for the boundary setting data 13b are associated with individual time frames.

Here, for example, it is assumed that the starting date of the time axis of a graph is defined as the aggregation execution date. However, any date after the aggregation execution date may be set as the starting date of the time axis of the graph. Furthermore, a plurality of pieces of aggregate data 13c may be generated in advance by setting dates within a specific period after the aggregation execution date as the individual starting dates of the time axis of the graph.

The receiving part 15b is a processing part that receives a graph generating instruction. Hereinafter, for example, it is assumed that an instruction for generating a graph regarding the planned production volume of the production plan data 13a is received from the head-office terminal 50. However, instructions for generating a graph regarding the planned production volume included in L-PIS plan data may be received from the base terminals 30.

The acquiring part 15c is a processing part that acquires the designation of the size of a time bucket representing the unit of a period. In as aspect, the acquiring part 15c acquires the designation of the size of a time bucket by reading the size designation data 13d stored in the storing unit 13. In another aspect, the acquiring part 15c may acquire the designation of the size of a time bucket input via a user interface of the head-office terminal 50.

The converting part 15d is a processing part that converts, using the aggregate data 13c, the planned production volume associated with a time frame having a size that is different from the designated size of a time bucket into the planned production volume for the designated size of the time bucket.

In an aspect, in the case where the “monthly basis” is set for the size designation data 13d, the converting part 15d converts the planned production volumes for individual time frames on the daily basis and the planned production volumes for individual time frames on the weekly basis of the aggregate data 13c stored in the storing unit 13 into the planned production volume per month. For example, in order to convert the planned production volume on the daily basis into the planned production volume per month, the converting part 15d performs the processing described below. That is, the converting part 15d performs conversion into the planned production volume per month by multiplying the planned production volume on the daily basis by the number of working days of the bases 3, such as, for example, the number of weekdays except for Saturdays, Sundays, and holidays, of the number of days constituting the month corresponding to the time frame for the planned production volume on the daily basis. Although the case where the planned production volume on the daily basis is multiplied by the number of working days is exemplified here, the planned production volume on the daily basis may be directly multiplied by the number of days constituting the month, such as, for example, twenty-eight days, thirty days, or thirty-one days. For another example, in order to convert the planned production volume on the weekly basis into the planned production volume per month, the converting part 15d performs conversion into the planned production volume per month by multiplying the planned production volume on the weekly basis by a specific multiple number, for example, “4” when it is assumed that the month is constituted by four weeks.

In another aspect, in the case where the “weekly basis” is set for the size designation data 13d, the converting part 15d converts the planned production volumes for individual time frames on the daily basis and the planned production volumes for individual time frames on the monthly basis of the aggregate data 13c stored in the storing unit 13 into the planned production volume per week. For example, in order to convert the planned production volume on the daily basis into the planned production volume per week, the converting part 15d performs the processing described below. That is, the converting part 15d performs conversion into the planned production volume per week by multiplying the planned production volume on the daily basis by the number of working days of the bases 3, such as, for example, the number of weekdays except for Saturdays, Sundays, and holidays, of the number of days constituting the week corresponding to the time frame for the planned production volume on the daily basis. Although the case where the planned production volume on the daily basis is multiplied by the number of working days is exemplified here, the planned production volume on the daily basis may be directly multiplied by the number of days constituting the week, such as seven days. For another example, in order to convert the planned production volume on the monthly basis into the planned production volume per week, the converting part 15d performs conversion into the planned production volume per week by multiplying the planned production volume on the monthly basis by a specific rate, such, as for example, “¼” when it is assumed that the month is constituted by four weeks.

In still another aspect, in the case where “the daily basis” is set for the size designation data 13d, the converting part 15d converts the planned production volumes for individual time frames on the weekly basis and the planned production volumes for individual time frames on the monthly basis of the aggregate data 13c stored in the storing unit 13 into the planned production volume per day. For example, in order to convert the planned production volume on the weekly basis into the planned production volume per day, the converting part 15d performs the processing described below. That is, the converting part 15d performs conversion into the planned production volume per day by dividing the planned production volume on the weekly basis by the number of working days of the bases 3, such as, for example, the number of weekdays except for Saturdays, Sundays, and holidays, of the number of days constituting the week corresponding to the time frame for the planned production volume on the weekly basis. Although the case where the planned production volume on the weekly basis is divided by the number of working days is exemplified here, division by the number of days constituting the week, such as seven days, may be done. For another example, in order to convert the planned production volume on the monthly basis into the planned production volume per day, the converting part 15d performs the processing described below. That is, the converting part 15d performs conversion into the planned production volume per day by dividing the planned production volume on the monthly basis by the number of working days of the bases 3, such as, for example, the number of weekdays except for Saturdays, Sundays, and holidays, of the number of days constituting the month corresponding to the time frame for the planned production volume on the monthly basis. Although the case where the planned production volume on the monthly basis is divided by the number of working days is exemplified here, division by the number of days constituting the month, such as, for example, twenty-eight days, thirty days, or thirty-first days, may be done.

In the case where a plurality of time-bucket sizes are designated for the size designation data 13d, the converting part 15d performs processing for conversion of the planned production volume so as to fit the individual sizes designated by the processing for designating the size. As described above, by performing conversion into designated time-bucket sizes for individual combinations, the graph indication described below is realized. For example, for the planned production volume on the monthly basis, the indication of a graph in which the planned production volumes on the daily basis and the weekly basis that are converted into the planned production volume per month is realized. Furthermore, for the planned production volume on the weekly basis, the indication of a graph in which the planned production volumes on the daily basis and the monthly basis that are converted into the planned production volume per week is realized. Furthermore, for the planned production volume on the daily basis, the indication of a graph in which the planned production volumes on the weekly basis and the monthly basis that are converted into the planned production volume per day is realized.

A graph including a combination of the planned production volume on the daily basis, the planned production volumes on the weekly basis and the monthly basis per day, the planned production volume on the weekly basis, the planned production volumes on the daily basis and the monthly basis per week, the planned production volume on the monthly basis, and the planned production volumes on the daily basis and the weekly basis per month, is indicated. Accordingly, the amount of information contained in one graph is significantly increased.

Although the case where conversion is performed using the planned production volume is exemplified here, conversion may not performed using only the planned production volume. For example, in order to convert the planned production volume on the daily basis into the planned production volume on the weekly basis or the monthly basis or to convert the planned production volume on the weekly basis into the planned production volume on the monthly basis, the device disclosed herein may perform conversion using the history of the past production volume, instead of the planned production volume. Accordingly, more accurate values are used for graph indication.

Furthermore, although the case where conversion is performed using the aggregate data 13c stored in the storing unit 13 is exemplified here, conversion may not be performed using the aggregate data 13c aggregated in advance. For example, the device disclosed herein may receive the setting of boundaries similar to the boundary setting data 13b, that is, “the number of days”, “the number of weeks”, and “the number of months”, from the head-office terminal 50 every time the device receives a graph generating instruction. In this case, every time a graph is referred to, the aggregate data 13c may be dynamically aggregated so as to fit the setting of boundaries received from the head-office terminal 50. Furthermore, the device disclosed herein may acquire the designation of size as well as a graph generating instruction for the size designation data 13d.

The generating part 15e is a processing part that generates, using the planned production volume converted by the converting part 15d, a graph representing the relationship between the planned production volume of a product and the passage of time.

In an aspect, in the case where only one time-bucket size is designated, the generating part 15e performs the processing described below. That is, the generating part 15e formats values in such a manner that for a time frame for which conversion is performed by the converting part 15d, the planned production volume after the conversion and the planned production volume before the conversion are indicated together. For example, the generating part 15e formats values in such a manner that the planned production volume after the conversion is indicated without a bracket and the planned production volume before the conversion is indicated within a bracket. Then, the generating part 15e performs settings in such a manner that a graph bar representing the planned production volume for a time frame for which conversion is performed is indicated in a format different from that for a graph bar for the planned production volume for a time frame for which conversion is not performed. For example, the generating part 15e sets indication forms in such a manner that a graph bar representing the planned production volume for a time frame for which conversion is performed is indicated so as to be uniformly painted and a graph bar representing the planned production volume for a time frame for which conversion is not performed is indicated so as to be painted with oblique lines. Then, the generating part 15e generates a bar graph in accordance with the numeric format and indication form set in advance, and the generated bar graph is displayed on the head-office terminal 50.

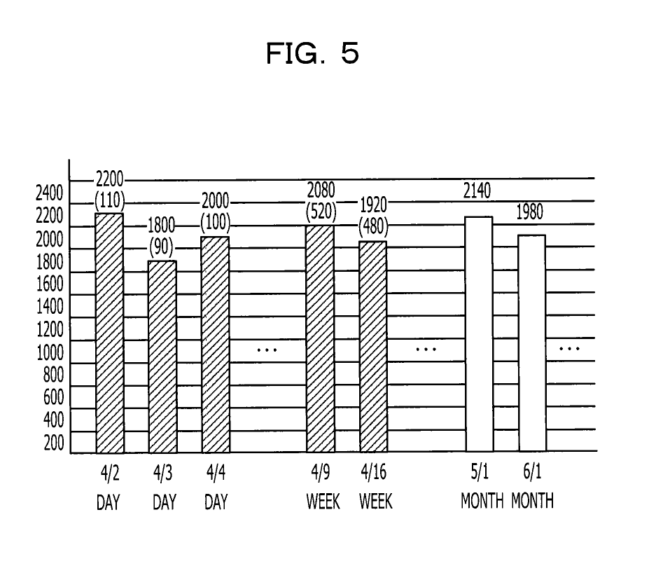

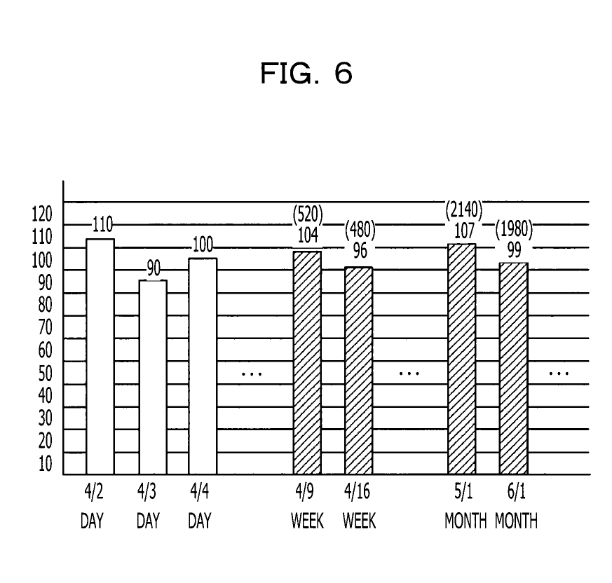

FIGS. 5 and 6 are diagrams illustrating examples of a graph. Each of the examples of FIGS. 5 and 6 illustrates a bar graph in the case where only one time-bucket size is designated. In FIGS. 5 and 6, the vertical axis of the graph represents planned production volume (the number of units) and the horizontal axis of the graph represents time. In the example of FIG. 5, a graph in which the planned production volumes for individual time frames are converted into the planned production volume per month is illustrated. In the example of FIG. 6, a graph in which the planned production volumes for individual time frames are converted into the planned production volume per day is illustrated. For generation of the graphs in FIGS. 5 and 6, the aggregate data 13c illustrated in FIG. 4 is used.

In the bar graphs illustrated in FIGS. 5 and 6, the planned production volume after conversion is performed is indicated without a bracket and the planned production volume before the conversion is performed is indicated within a bracket. Thus, the planned production volume before conversion is performed as well as the planned production volume after the conversion is performed is clear from the bar graphs illustrated in FIGS. 5 and 6. Furthermore, in the bar graphs illustrated in FIGS. 5 and 6, graph bars representing the planned production volumes for time frames for which conversion is performed are indicated so as to be uniformly painted and graph bars representing the planned production volumes for time frames for which the conversion is not performed are indicated so as to be painted with oblique lines. Thus, the fact that the planned production volumes for individual time frames on the daily basis and the planned production volumes for individual time frames on the weekly basis are converted into the planned production volume per month is clear from the bar graph illustrated in FIG. 5. Furthermore, the fact that the planned production volumes for individual time frames on the weekly basis and the planned production volumes for individual time frames on the monthly basis are converted into the planned production volume per day is clear from the bar graph illustrated in FIG. 6. As described above, with the indication of the bar graphs illustrated in FIGS. 5 and 6 in which the scale for the planned production volume is unified to the monthly basis or the daily basis, a person in charge of the production department of the head office 5 is able to determine the size relationship of planned production volumes even at the boundary between the daily basis and the weekly basis and the boundary between the weekly basis and the monthly basis.

In another aspect, in the case where a plurality of time-bucket sizes are designated, the generating part 15e performs the processing described below. That is, the generating part 15e performs numeric formatting in which the scale of an axis representing planned production volume of the axes forming a graph is adjusted to the scale in which the planned production volumes for all the time frames on the daily basis to the monthly basis are indicated. Then, the generating part 15e sets the indication form in such a manner that separations are indicated at the positions of the planned production volumes or the positions of the converted values for time frames in graph bars representing the planned production volumes for the individual time frames. Furthermore, the generating part 15e sets the indication form in such a manner that a region to which the planned production volume for the time-bucket size before conversion is performed belongs is indicated so as to be painted in a way different from those for the other regions in graph bars representing the planned production volumes for the individual time frames. Then, the generating part 15e generates a bar graph in accordance with the numeric format and indication form set in advance, and the generated bar graph is displayed on the head-office terminal 50.

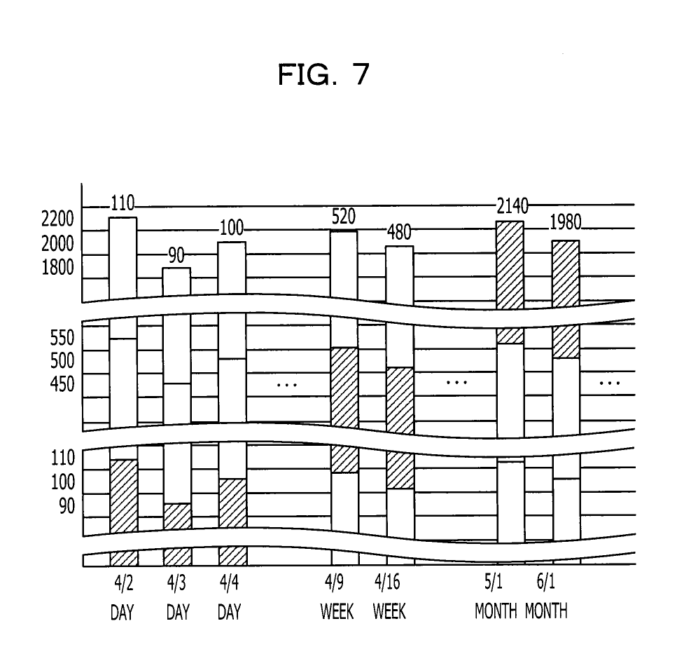

FIG. 7 is a diagram illustrating an example of a graph. In the example of FIG. 7, a bar graph in the case where three time-bucket sizes, that is, the daily basis, the weekly basis, and the monthly basis, are designated is illustrated. In FIG. 7, the vertical axis of the graph represents planned production volume (the number of units) and the horizontal axis of the graph represents time. For generation of the graph in FIG. 7, the aggregate data 13c illustrated in FIG. 4 is used.

In the bar graph illustrated in FIG. 7, separations are indicated at the positions of the planned production volumes or the positions of the converted values for time frames in graph bars representing the planned production volumes for the individual time frames. Furthermore, in the bar graph illustrated in FIG. 7, wavy lines are inserted among a value range in which the planned production volume on the daily basis is indicated, a value range in which the planned production volume on the weekly basis is indicated, and a value range in which the planned production volume on the monthly basis is indicated. Thus, even in the case where planned production volumes are indicated with different three granularities, the size relationship among the granularities is easily determined from the bar graph illustrated in FIG. 7. Furthermore, in the bar graph illustrated in FIG. 7, a region to which the planned production volume for a time-bucket size before conversion is performed belongs is indicated so as to be painted in a way different from those for the other regions in graph bars representing the planned production volumes for the individual time frames. Thus, it is easily understood, from the bar graph illustrated in FIG. 7, from which time-bucket size to which time-bucket size the planned production volume is converted. By viewing the bar graph illustrated in FIG. 7, a person in charge of the production department of the head office 5 is able to determine the size relationship of the planned production volumes even at the boundary between the daily basis and the weekly basis and the boundary between the weekly basis and the monthly basis.

Various integrated circuits and electronic circuits may be used for the control unit 15. Furthermore, part of a functional section of the control unit 15 may be another integrated circuit or electronic circuit. For example, an ASIC (Application Specific Integrated Circuit) may be adopted as the integrated circuit. Furthermore, a CPU (Central Processing Unit) or an MPU (Micro Processing Unit) may be adopted as the electronic circuit.

[Process Flow]

The flow of the process performed by the production management server 10 according to this embodiment will now be explained. Here, after (1) aggregation process performed by the production management server 10 is explained, (2) graph generating process will be explained.

(1) Aggregation Process

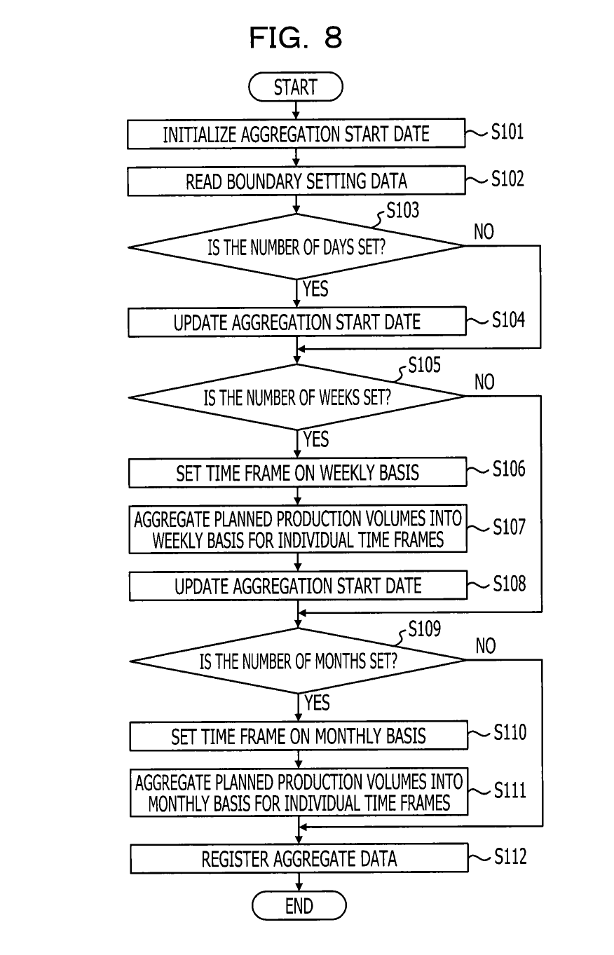

FIG. 8 is a flowchart illustrating the procedure of an aggregation process according to the first embodiment. In the case where settings for the boundary setting data 13b are registered or changed, the case where the production plan data 13a is updated, the case where the date changes, or the like, the aggregation process starts.

As illustrated in FIG. 8, the aggregating part 15a initializes the aggregation start date to the starting date of the time axis of a graph (step S101). Then, the aggregating part 15a reads the boundary setting data 13b stored in the storing unit 13 (step S102). Then, the aggregating part 15a determines whether or not “the number of days” is set for the boundary setting data 13b (step S103).

When “the number of days” is set for the boundary setting data 13b (affirmative in step S103), the aggregating part 15a performs the processing described below. That is, the aggregating part 15a updates the aggregation start date, on which aggregation of the production plan data 13a starts, by adding the number of days for which the planned production volume on the daily basis is to be indicated to the starting date of the time axis of the graph (step S104).

When “the number of days” is not set for the boundary setting data 13b (negative in step S103), the planned production volume on the daily basis is not indicated in a graph to be generated in the subsequent graph generating processing, and indication starts from the planned production volume on the weekly basis. Thus, since the starting date of the time axis of the graph is directly defined as the date on which indication of the planned production volume on the weekly basis starts, the aggregation start date is not updated in this case. The process proceeds to step S105.

Then, the aggregating part 15a determines whether or not “the number of weeks” is set for the boundary setting data 13b (step S105). When “the number of weeks” is set for the boundary setting data 13b (affirmative in step S105), the aggregating part 15a performs the processing described below.

That is, the aggregating part 15a sets time frames on the weekly basis for the period from the starting date, which is the aggregation start date, to the finish date, which is the date after the number of weeks set for the boundary setting data 13b has passed (step S106).

Then, the aggregating part 15a aggregates the planned production volumes on the daily basis within the set time frames of the planned production volumes of the production plan data 13a into the planned production volumes on the weekly basis (step S107). Then, the aggregating part 15a updates the aggregation start date by adding the number of weeks for which the planned production volume on the weekly basis is to be indicated to the aggregation start date stored in the internal memory, which is not illustrated (step S108).

When “the number of weeks” is not set for the boundary setting data 13b (negative in step S105), since the planned production volume on the weekly basis is not indicated in a graph to be generated in the subsequent graph generating processing, aggregation on the weekly basis and updating of the aggregation start date are not performed. The process proceeds to step S109.

Then, the aggregating part 15a determines whether or not “the number of months” is set for the boundary setting data 13b (step S109). When “the number of months” is not set for the boundary setting data 13b (negative in step S109), aggregation on the monthly basis and updating of the aggregation start date are not performed. The process proceeds to step S112.

When “the number of months” is set for the boundary setting data 13b (affirmative in step S109), the aggregating part 15a performs the processing described below. That is, the aggregating part 15a sets time frames on the monthly basis for the period from the starting date, which is the aggregation start date, to the finish date, which is the date after the number of months set for the boundary setting data 13b has passed (step S110).

Then, the aggregating part 15a aggregates the planned production volumes on the daily basis within the set time frames of the planned production volumes of the production plan data 13a into the planned production volumes on the monthly basis (step S111).

Then, the aggregating part 15a registers to the storing unit 13 the aggregate data 13c in which the planned production volume on the daily basis, the planned production volume on the weekly basis, and the planned production volume on the monthly basis corresponding to the number of days set for the boundary setting data 13b are associated with individual time frames (step S112). Then, the process is terminated.

(2) Graph Generating Process

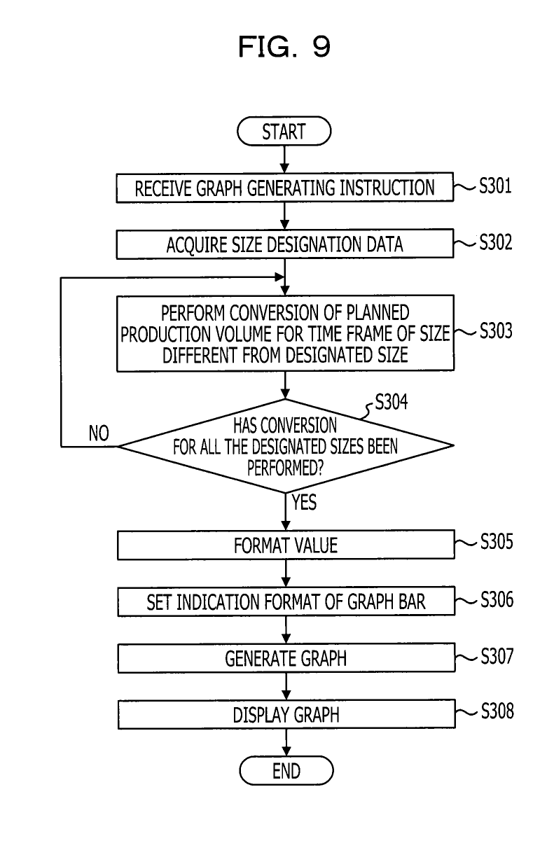

FIG. 9 is a flowchart illustrating the procedure of a graph generating process according to the first embodiment. When a graph generating instruction is received from the head-office terminal 50 or the like, the graph generating process starts.

As illustrated in FIG. 9, when receiving a graph generating instruction from the head-office terminal 50 or the like (step S301), the acquiring part 15c reads the size designation data 13d stored in the storing unit 13 to acquire the designation of the size of a time bucket (step S302).

Then, the converting part 15d converts, using the aggregate data 13c stored in the storing unit 13, the planned production volume associated with a time frame of a size different from the designated size set for the size designation data 13d into the planned production volume for the same size as the designated time-bucket size (step S303).

Then, until conversion for all the designated sizes set for the size designation data 13d is completed (negative in step S304), the converting part 15d repeats the processing of step S303.

After conversion for all the designated sizes set for the size designation data 13d is completed (affirmative in step S304), the generating part 15e performs the processing described below. That is, the generating part 15e formats values in such a manner that for a time frame for which conversion is performed by the converting part 15d, the planned production volume after the conversion and the planned production volume before the conversion are indicated together (step S305).

Then, the generating part 15e sets an indication form in such a manner that a graph bar representing the planned production volume for a time frame for which conversion is performed is indicated in a way different from a graph bar representing the planned production volume for a time frame for which conversion is not performed (step S306).

Then, the generating part 15e generates a bar graph in accordance with the set numeric format and indication form (step S307). Then, the generating part 15e causes the bar graph generated in step S307 to be displayed on the head-office terminal 50 (step S308). The process is terminated.

As described above, in the case where planned product production volumes for different time-bucket sizes exist in a graph to be generated, the production management server 10 according to this embodiment converts the planned production volume for a time-bucket size into the planned production volume per a different time-bucket size, and generates a graph. For example, a person in charge of a production department is able to determine the size of planned production volume only by simply comparing the height of a bar on the weekly basis with the height of a bar on the monthly basis in a bar graph. Thus, the person in charge of the production department is able to understand, without interruption, the trend of the planned production volume before and after the boundary at which the time-bucket size changes. Consequently, with the production management server 10 according to this embodiment, the visibility of a graph is improved.

### Second Embodiment

An embodiment of the disclosed device has been explained above. However, the present disclosure may have various other embodiments as well as the embodiment described above. Hereinafter, other embodiments included in this disclosure will be explained.

[Graph Indication]

For example, a graph may be generated in which a time frame shorter than a time-bucket size is indicated in a way different from a time frame having the same size as the time-bucket size. That is, depending on the boundary settings set for the boundary setting data 13b, even if boundary setting for a bucket size on the weekly basis or the monthly basis is done, a time frame shorter than a week or shorter than a month may exist. For example, in the case where a later part of a month is set as “the number of weeks” for the boundary setting data 13b, the number of days from the date immediately after the indication finish date on the daily basis to the end of the month may not be a multiple of 7, and a time frame may be shorter than 7 days, for example, the last time frame may be shorter than a week, such as one day to 6 days. In this case, if a time frame shorter than a week is indicated similarly to a time frame having one week or if a time frame shorter than a month is indicated similarly to a time frame having one month, the size relationship of planned production volumes may not be determined correctly.

Thus, the disclosed device indicates a time frame shorter than a time-bucket size in a way different from a time frame having the same size as the time-bucket size and thus is capable of warning not to cause incorrect determination as to the size relationship.

[Application Example Of Conversion]

Furthermore, the disclosed device is also capable of converting the planned production volume for a time frame shorter than a time-bucket size into the planned production volume per the time frame having the same size as the time-bucket size. For example, in the case where a time frame that is to have the same size as a time-bucket size is actually a time frame for three days, conversion into the planned production volume for one week is realized by dividing the planned production volume for three days by three and then multiplying the obtained value by the number of working days of the week. Thus, even in the case where a time frame shorter than a time-bucket size exists in a graph, the size relationship of planned production volumes is easily determined.

[Dispersion And Integration]

Individual component parts of the illustrated individual devices may not be physically configured as illustrated. That is, a specific form of dispersion and integration of the individual devices may not be as illustrated. All or part of the individual devices may be dispersed or integrated functionally or physically in desired units, in accordance with various loads and use conditions. For example, the aggregating part 15a, the receiving part 15b, the acquiring part 15c, the converting part 15d, or the generating part 15e may be connected over a network as an external device of the production management server 10. Furthermore, by providing the aggregating part 15a, the receiving part 15b, the acquiring part 15c, the converting part 15d, and the generating part 15e in different devices, connecting these parts over a network, and causing these parts to work together, the functions of the production management server 10 may be implemented.

[Graph Generating Program]

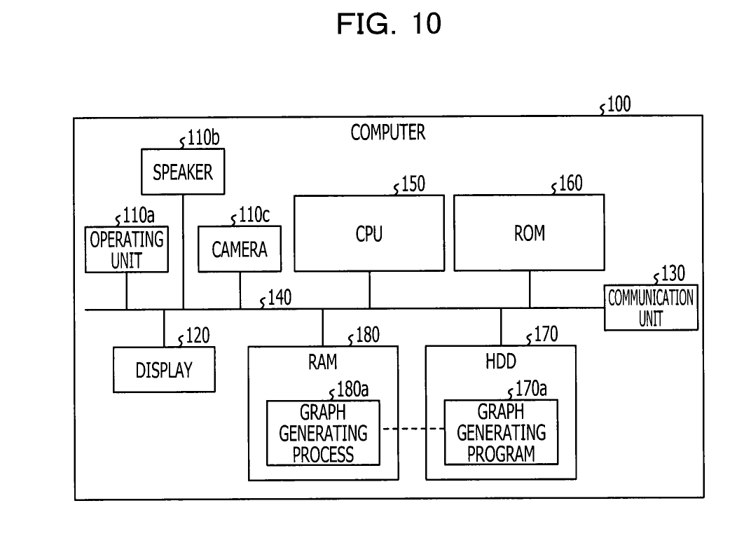

The various types of processing described in the foregoing embodiments may be implemented by executing, with a computer such as a personal computer or a work station, programs prepared in advance. Hereinafter, an example of a computer that executes a graph generating program having a function similar to those of the foregoing embodiments will be explained with reference to FIG. 10.

FIG. 10 is a diagram for explaining an example of a computer that executes a graph generating program according to the first and second embodiments. As illustrated in FIG. 10, a computer 100 includes an operating unit 110a, a speaker 110b, a camera 110c, a display 120, and a communication unit 130. The computer 100 also includes a CPU 150, a ROM 160, an HDD 170, and a RAM 180. The units 110 to 180 are connected to one another via a bus 140.

As illustrated in FIG. 10, a graph generating program 170a implementing functions similar to those of the aggregating part 15a, the receiving part 15b, the acquiring part 15c, the converting part 15d, and the converting part 15d described in the first embodiment is stored in advance in the HDD 170. The graph generating program 170a may be integrated or separated in an appropriate manner, similarly to the component parts illustrated in FIG. 2, that is, the aggregating part 15a, the receiving part 15b, the acquiring part 15c, the converting part 15d, and the generating part 15e. That is, all the data may not be stored in the HDD 170, and only data to be used for processing may be stored in the HDD 170.

Then, the CPU 150 reads the graph generating program 170a from the HDD 170 and loads the read graph generating program 170a to the RAM 180. Accordingly, as illustrated in FIG. 10, the graph generating program 170a functions as a graph generating process 180a. The graph generating process 180a loads, in an appropriate manner, various data read from the HDD 170 to a region of the RAM 180 allocated to the graph generating process 180a, and performs various types of processing on the basis of the loaded various data. The graph generating process 180a includes processing performed by the aggregating part 15a, the receiving part 15b, the acquiring part 15c, the converting part 15d, and the generating part 15e illustrated in FIG. 2, that is, for example, the processing illustrated in FIGS. 8 and 9. Furthermore, all the various processing units virtually implemented on the CPU 150 may not operate on the CPU 150. Only a processing unit to be used for processing may be virtually implemented.

The graph generating program 170a may not be initially stored in the HDD 170 or the ROM 160. For example, individual programs are stored in a flexible disk to be inserted into the computer 100, that is, a so-called “portable physical medium”, such as an FD, a CD-ROM, a DVD disk, a magneto-optical disk, or an IC card. The computer 100 may acquire the individual programs from a portable physical medium and execute the acquired programs. Furthermore, the individual programs may be stored in another computer or a server device connected to the computer 100 over a public line, the Internet, a LAN, a WAN or the like, and the computer 100 may acquire the programs and execute the acquired programs.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention has been described in detail, it should be understood that the various changes, substitutions, and alterations could be made hereto without departing from the spirit and scope of the invention.

What is claimed is:

1. A computer-readable recording medium storing a program for causing a computer to execute a procedure for graph generation, the procedure comprising:
receiving an instruction for generating a graph regarding production of a product in a chronological manner for each of first unit period and second unit period that is longer than the first unit period;
referring to aggregate data on production volumes for individual unit periods including the first unit period and the second unit period, and calculating, based on a production volume for a different unit period having a length that is different from a length of a designated unit period of the first unit period and the second unit period, a different production volume to be obtained by converting the different unit period into the designated unit period; and
generating the graph in such a manner that at least the different production volume is indicated for the different unit period having the length that is different from the length of the designated unit period.

2. The computer-readable recording medium according to claim 1, wherein in a case where the first unit period has a length that is different from the length of the designated unit period, the generating generates the graph in such a manner that the different production volume for the first unit period is indicated in a way that is different from a production volume for the second unit period.

3. The computer-readable recording medium according to claim 1, wherein the generating generates the graph in such a manner that the production volume before conversion into the designated unit period is performed as well as the different production volume is indicated.

4. The computer-readable recording medium according to claim 1, wherein in a case where a plurality of unit periods are designated, the calculating calculates different production volumes for the individual designated unit periods.

5. A graph generating method to be executed by a computer, the graph generating method comprising:
receiving an instruction for generating a graph regarding production of a product in a chronological manner for each of first unit period and second unit period that is longer than the first unit period;
referring to aggregate data on production volumes for individual unit periods including the first unit period and the second unit period, and calculating, based on a production volume for a different unit period having a length that is different from a length of a designated unit period of the first unit period and the second unit period, a different production volume to be obtained by converting the different unit period into the designated unit period; and
generating the graph in such a manner that at least the different production volume is indicated for the different unit period having the length that is different from the length of the designated unit period.

6. The graph generating method according to claim 5, wherein in a case where the first unit period has a length that is different from the length of the designated unit period, the generating generates the graph in such a manner that the different production volume for the first unit period is indicated in a way that is different from a production volume for the second unit period.

7. The graph generating method according to claim 5, wherein the generating generates the graph in such a manner that the production volume before conversion into the designated unit period is performed as well as the different production volume is indicated.

8. The graph generating method according to claim 5, wherein in a case where a plurality of unit periods are designated, the calculating calculates different production volumes for the individual designated unit periods.

9. A production management device comprises:
a memory configured to store aggregate data on production volumes for individual unit periods including first unit period and second unit period that is longer than the first unit period; and
a processor configured to execute a procedure, the procedure comprising:
receiving an instruction for generating a graph regarding production of a product in a chronological manner for each of first unit period and second unit period;
referring to the memory and calculating, based on a production volume for a different unit period having a length that is different from a length of a designated unit period of the first unit period and the second unit period, a different production volume to be obtained by converting the different unit period into the designated unit period; and
generating the graph in such a manner that at least the different production volume is indicated for the different unit period having the length that is different from the length of the designated unit period.

10. The production management device according to claim 9, wherein in a case where the first unit period has a length that is different from the length of the designated unit period, the generating generates the graph in such a manner that the different production volume for the first unit period is indicated in a way that is different from a production volume for the second unit period.

11. The production management device according to claim 9, wherein the generating generates the graph in such a manner that the production volume before conversion into the designated unit period is performed as well as the different production volume is indicated.

12. The production management device according to claim 9, wherein in a case where a plurality of unit periods are designated, the calculating calculates different production volumes for the individual designated unit periods.
